(19) United States
(12) Patent Application Publication
(10) Pub. No.: US 2013/0313968 A1
(43) Pub. Date: Nov. 28, 2013

(54) EL ELEMENTS CONTAINING A PIGMENT LAYER COMPRISING CROSSLINKING SYSTEMS WITH BLOCKED ISOCYANATE GROUPS

(71) Applicants: Joachim Wagner, Koln (DE); Sebastian Dörr, Dusseldorf (DE); Thomas Bernert, Leverkusen (DE)

(72) Inventors: Joachim Wagner, Koln (DE); Sebastian Dörr, Dusseldorf (DE); Thomas Bernert, Leverkusen (DE)

(73) Assignee: BAYER INTELLECTUAL PROPERTY GMBH, Monheim (DE)

(21) Appl. No.: 13/989,044

(22) PCT Filed: Nov. 21, 2011
(86) PCT No.: PCT/EP2011/070555

§ 371 Date: Aug. 7, 2013

(30) Foreign Application Priority Data
Nov. 25, 2010 (DE) 10 2010 061 963.9

(51) Int. Cl. H05B 33/14

(52) U.S. Cl. CPC H05B 33/14
USPC 313/503

(57) ABSTRACT

The present invention relates to formulations for the production of an electroluminescent element, comprising a substrate, an at least partly transparent front electrode, at least one pigment layer, optionally a dielectric layer, a back electrode and busbars for contacting the electrodes, optionally a covering layer or a laminate, and a process for the production of an electroluminescent element, preferably by screen minting. The formulations for the production of the pigment and dielectric layer contain as binders isocyanate-reactive components and blocked isocyanates and/or blocked di- and/or polyisocyanates.

The present invention relates to formulations for the production of eleetroluminescent film elements (abbreviated to EL elements in the following) and a process for the production of film elements according to the invention, for example by the screen printing process, using formulations and pastes which contain blocked isocyanates as the curing agent component of the binder.

Two-dimensional EL elements are adequately known from the prior art, bat three-dimensionally shaped EL elements have also been proposed.

DE-A 44 30 907 relates to an arrangement for the formation of a three-dimensional electroluminescent display in which curved or profiled surfaces are luminescent.

DE-A 102 34 031 relates to an electroluminescent luminous area which comprises a carrier layer provided with information and is produced from a film material which can be freely shaped or from a hard material which has a three-dimensionally shaped surface. The electroluminescent luminous area is produced by first printing the carrier layer with information and then providing it with a first electrically conductive layer, a pigment layer, an insulating and reflecting layer, aback electrode and an optional protective layer. Polyurethanes as binders for the various layers are not mentioned.

WO 03/037039 relates to a three-dimensional electroluminescent display which comprises a main body and an electroluminescent device. The main body of the electroluminescent display is made of a suitable plastic, which can advantageously be processed in an injection moulding process. For production of the three-dimensional electroluminescent display, the electroluminescent device is first produced. The electroluminescent device is then shaped. .After the shaping (thermoforming), the electroluminescent device can be subjected, for example, to insert moulding. Here also, no polyurethanes are described as binders for formulations for the production of the layers of the electroluminescent device.

For the production of three-dimensionally shaped EL elements, polycarbonate films are preferably provided with an EL layer construction and are then preferably subjected to thermoforming in the high pressure forming process (HPF), as described, for example, in WO 2009/043539.

Specific two-component polyurethanes have already been proposed in the prior art as preferred. binders for pastes for the production of EL elements which can also be shaped three-dimensionally. Thus, WO 2008/071412 describes a flexible 3D-EL-HPF element, the production process and its use.

WO 2008/068016 describes an EL element which comprises a semitransparent metal foil and its production and uses thereof. The EL element described is likewise produced using two-component polyurethanes.

One component of the two-component polyurethanes is a di- or polyisocyanate, and the other component is an isocyanate-reactive component, such as, for example, polyamines or, preferably, diols and polyols.

The abovementioned documents describe the use of polyurethanes for the production of EL elements, but the use of blocked isocyanates and advantages thereof are not described.

For production of EL elements, the layers described are applied successively, preferably with intermediate drying and/or crosslinking, by printing on or coating with formulations, inks, pastes, printing inks or lacquers. Suitable processes for application of the layers are in principle all the coating and printing processes known to the person skilled in the art, for example knife coating, lacquer spin coating, dip coating, spray coating, slot die coating, curtain coating, relief printing, flatbed printing, screen printing, flexographic printing, gravure printing, intaglio printing, pad printing, offset printing, digital printing and thermotransfer printing, Preferably, the screen printing process serves as the process. Formulations, inks, pastes, printing inks or lacquers are generally called formulations in the following.

Binders based on two-component polyurethanes indeed have the flexibility necessary for the shaping, However, the two-component polyurethane systems described have the limitation that the pot life of the formulations is limited. This can be a disadvantage in the production process, since the viscosity of the formulation increases with advancing processing time. In screen printing specifically, adverse effects on the EL elements may result, such as e.g. a layer thickness which is not constant within a sample from the first to the last sheet. As a result, the brightnesses of the individual lamps also vary in a sample, since the luminescence of the EL element is darker with increasing thickness of the pigment and dielectric layer. In addition, the handling of the formulations is difficult, since the formulation polymerizes continuously after preparation, even in a closed vessel, and the viscosity therefore increases. In the event of delays in the production process, a formulated batch must therefore be discarded When it has exceeded the pot life and a new batch must be prepared. This adversely affects the profitability of the process when these polyurethanes are used. Cleaning specifically of the screen fabric in the screen printing process is furthermore more difficult, when two-component polyurethanes are used.

The pot life is the term for the time from preparation of the formulation to the end of its processability. In screen printing, a paste can no longer be processed (end of the processability reached) when a loss in quality occurs in the print layer, such as, for example, formation of stripes, increase in the thickness of the print layer or blocking of the screen meshes, in the case of spraying, for example, blocking of the spray guns and an increase in the layer thickness of the layers applied, and in the case of knife coating, for example, an increase in the layer thickness of the layers applied. The layer thicknesses which are still tolerable must be adapted to a production process and specified. If these specified limits are exceeded, the formulation is to be discarded, since it has exceeded its pot life.

The object of the present invention was to provide a technology which uses as binders for formulations for the production of EL elements two-component polyurethanes which, however, do not have the disadvantages described, such as limited pot lives, and as far as possible show no increase in the viscosity during processing, for example if processing is interrupted.

It has now been found, surprisingly for the person skilled in the art, that blocked diisocyanates and blocked polyisocyanates are also suitable for the preparation of formulations with which EL elements can be produced. Since the blocked isocyanate/di- or polyisocyanate does not react with the isocyanate-reactive component, for example the polyol, but reacts only after the blocking group has been split off, the pot life is prolonged. Instead of some hours, it is, for example, more than three months. As a result a one-component system with long-term stability can in principle be provided for production of the particular layer. The viscosity of the formulation thus also no longer increases due to chemical crosslinking during the application process, and only evaporation of any solvents added may increase the viscosity somewhat. However, this is precisely the case for all formulations of the prior art to which solvents have been added. By using relatively high-boiling solvents, such as, for example, methoxypropyl acetate (boiling range 145-147° C.) or ethoxypropyl acetate (boiling range 158-160° C.), evaporation of the solvent can be minimized, Stable layer thicknesses can thus be achieved during printing. Only during drying at elevated temperature, for example in a belt drier and/or in a drying cabinet, is the blocking group split off, and the isocyanate reacts with the polyol. Blocking group in the context of the invention is a chemical group on the isocyanate which is bonded to the isocyanate groups by reaction of the isocyanate with a blocking agent and which is split off thermally on heating of the isocyanate and leaves behind the isocyanate such as was present before reaction with the blocking agent. The reaction of the blocked isocyanate with the isocyanate-reactive compound can also proceed in a concerted manner with simultaneous deblocking. Blocking group in the context of the invention is also a chemical group on the isocyanate which is not split off during curing but leads to branching or crosslinking by other reactions (e.g. transesterification in the case of reaction of malonate-blocked polyisocyanates with polyols). Blocking agents for isocyanate groups are known to the person skilled in the art.

While if two-component polyurethane systems are used formulations which have already been prepared can no longer be used after use, in the case of two-component systems with blocked diisocyanates and polyisocyanates unused residues can be stored in closed vessels and put to further use. This increases the profitability, since the costs above all for the luminescent pigments used in the pigment layer are high.

An EL element has a carrier or a substrate (1), an at least partly transparent front electrode (2), a layer (3) which contains crystals which are luminescent in an electric field, optionally a dielectric layer (4) which increases the dielectric strength of the layer construction and has a dielectric constant which is as high as possible, a further electrode layer (5), optionally silver amplifiers, so-called silver busbars (6) for the electrodes and optionally a covering layer (7). The EL element can furthermore optionally be laminated in order to protect it from external influences.

The invention therefore provides an EL element comprising a substrate, a front and a back electrode and a pigment layer, wherein the pigment layer comprises:
a) a binder system comprising
   a component with thermally reversibly blocked isocyanate groups aa)
   and one or more isocyanate-reactive components ab) and
b) pigments or crystals which are luminescent in an electric field.

The layer construction described means that the lamp luminesces through the substrate (1) (conventional construction), However, the layers can also be arranged such that the lamp luminesces to the side facing away from the substrate (layer construction, for example, (1), (5), (4), (3), (2), (6)). The covering layer (6) or the protective laminate must then be at least partly transparent. This arrangement is called inverse. An EL element can furthermore also luminesce in both directions. This arrangement is called double-sided. An at least partly transparent covering layer or an at least partly transparent protective laminate is understood as meaning a covering layer or a protective laminate with a transmission of the incident light of at least one per cent.

### DESCRIPTION OF THE INDIVIDUAL LAYERS AND COMPONENTS

Substrate (1)

Many materials can be used as the substrate for an EL element. The EL element conventionally luminesces through the substrate (conventional construction). At least partly transparent materials, such as, for example, glass, plastics or films of plastic, are therefore particularly suitable as substrates. All the known materials are suitable as the material for films of plastic. A large number of electroluminescent elements comprise polyester films or polyethylene terephthalate films as the carrier material on an electrically conducting, largely transparent layer vapour-deposited, for example, in the sputtering process. In addition, such EL elements in general comprise further layers, for example protective layers. Since these layers employed in the prior art for the production of EL elements often have a brittle character or do not withstand a shaping process with high temperatures, the conventional EL elements in general are flat in construction, Which, for example in the case of objects which have a three-dimensional geometry, can lead to an impairment in the perceptibility of information and in the operability. In particular, polycarbonate, such as is contained, for example, in the films called Makrofol® and Bayfol10 (Bayer MaterialScience AG, D-51368 Leverkusen, www.bayermaterialscience.com), are very particularly suitable especially for three-dimensionally shaped EL elements.

Electrically Conductive Layers (2) and (4)

In the conventional construction, a first electrically conductive layer which is at least partly transparent is applied to the substrate, in the inverse construction such an electrically conductive layer is applied to the pigment layer. An at least partly transparent, electrically conductive layer means a transmission of the incident light through the layer of at least 30%, preferably more than 70%, particularly preferably more than 80%. Such layers are known in the prior art, and indium tin oxide (ITO) or antimony tin oxide (ATO) are often used for EL elements which are not three-dimensionally shaped. PET films with ITO coatings are commercially obtainable, for example from Sheldahl (1150 Sheldahl Road, Northfield, Minn. 55057). Screen printable formulations which are suitable for the production of at least partly transparent, electrically conductive coatings are also obtainable, for example the ATO screen printing pastes with the designations 7162E or 7164 from DuPont (DuPont (UK) Limited, Coldharbour Lane, Frenchay, Bristol BS16 1QD, England). There are furthermore also electrically conductive polymers, such as PEDOT/PSS (poly-3,4-dioxythiophene), which is obtainable under the brand name Clevios® from H. C. Starck (H.C. Starck GmbH, Postfach 2540, 38615 Goslar, Germany) or polyaniline, which are suitable for the formation of the electrically conductive electrode layers. Screen printing pastes which contain these polymeric, electrically conductive materials are commercially available, such as, for example, the Orgacon EL-P 3000 series from Agfa (Agfa-Gevaert NV, Septestraat 27, B-2640 Mortsel, Belgium) or the screen printing pastes from Ormecon (Ormecon GmbH, Ferdinand-Harten Str. 7, D-22941 Ammersbeck, Germany). Preferably, the Clevios poly(3,4-ethylenedioxythiophene) system from H.C. Starck GmbH, which is formulated with solvents, additives and a polymer dispersion, is employed as the electrically conductive constituent of a formulation for the production of the at least partly transparent electrode of the electroluminescent element.

The electrically conductive layer which is arranged on the side opposite to the luminescence of the EL element does not have to be transparent. Further materials which are not suitable for use in an at least partly transparent electrically conduct we layer can therefore be used. For example, electrically conductive screen printing pastes with a silver filler content are particularly suitable for production of the back electrode. Other metals or carbon can furthermore also be used as fillers which conduct an electric current. Screen printable silver pastes are, for example, Electrodag® 410 or Electrodag® PM 470 from Acheson (Acheson France S.A.S., 67152 Erstein Cedex, France) and the 9145 Electroluminescent Silver Conductor Paste from DuPont (DuPont (UK) Limited, Coldharbour Lane, Frenchay, Bristol BS16 1QD, England). Electrically conductive, screen printable pastes for production of a non-transparent electrode which have a carbon filler content are, for example, the 8144 Electroluminescent Carbon Conductor Paste from DuPont (DuPont (UK) Limited, Coldharbour Lane, Frenchay, Bristol BS16 1QD, England), or the Electrodag® PF 407 A from Acheson (Acheson France SAS,, 67152 Erstein Cedex, France).

Covering Layer (5)

Commercial lacquers or printing inks such as are available, for example, under the brand names Noriphan HTR, Noriphan PCI, Noriphan N2K, Noricryl or NoriPET from Pröll KG (Treuchtlinger Straβe 29, D-91781 Weiβenburg Bay.) or are marketed under Maraflex FX by Marabu GmbH & Co, KG (Asperger Straβe 4, D-71732 Tamm), Polyplast PY by Nifilm Sericol Deutschland GmbH (Postfach 10 15 55, D-46215 5 Bottrop) or screen printing inks HG, SG, CP, CX, PK, J, TL and YN by Coates Screen Inks GmbH (Wiederholdplatz 1, D-90451 Nürnberg) or 1500 Series UV Flexiform, 1600 Power Print Series, 1700 Versa Print, 3200 Series, 1800 Power Print plus, 9700 Series, PP Series, 7200 Lacquer, 7900 Series by Nazdar (8501 Hedge Lane Terrace, Shawnee, Kans. 66227-3290 USA), are suitable as the covering layer. The formulations can be water-based, solvent-based or solvent-free in construction. The formulations can be crosslinkable by means of UV radiation, thermally crosslinking and/or drying and/or IR crosslinking/drying.

As an alternative to a covering lacquer or in addition to this, the EL element can be laminated on the front and reverse with a further protective layer. Suitable protective layers are all the materials known to the person skilled in the art which are suitable for lamination.

Silver Busbars (6)

In order to contact the electrodes, as a rule silver busbars are used since the electrode material would lead to high contact resistances at the contact sites. Silver busbar is the term for a structure which is printed from silver conductive pastes and as a rule conducts the current from the contact into a relatively large area, Many suitable silver pastes are used in the prior art, for example Electrodag® PF 410 or Electrodag® PM 470 from Acheson (Acheson France S.A.S., 67152 Erstein Cedex, France), 9145 Electroluminescent Silver Conductor or 5028 Silver Conductor from DuPont (DuPont (UK) Limited, Coldharbour Lane, Frenchay, Bristol BS16 1QD, England) or ELX30 Silver Conductive Paste from Electra Polymers Ltd. (Roughway Mill, Tonbridge, Kent, TN11 9SG, England).

If the back electrode of the EL element is already made of a layer with a silver filler content, amplification with a silver busbar as a rule is not necessary.

Pigment Layer (3)

The pigment layer comprises

a) a binder system comprising at least
one component with thermally reversibly blocked isocyanate groups aa)
and one or more isocyanate-reactive components ab)

b) pigments or crystals which are luminescent in an electric field,

c) optionally solvents

d) optionally additives and additional substances,

a) Binder System

The screen printing pastes for the production of print layers for EL elements according to the invention contain a binder with a blocked isocyanate and at least one isocyanate-reactive component, preferably a polyol.

The ratios of the amounts of the reaction partners are preferably chosen such that the ratio of the equivalents of the groups which are reactive towards isocyanate to the isocyanate is 1:0.2 to 1:3, preferably 1:0.5 to 1:1.5 and very particularly preferably 1.

The NCO-functional compounds known per to the person skilled in the art which have a functionality of preferably 2 or more can be used as suitable polyisocyanates for the preparation of component aa). These are typically aliphatic, cycloaliphatic, araliphatic and/or aromatic di- or triisocyanates and higher molecular weight secondary products thereof with iminooxadiazinedione, isocyanurate, uretdione, urethane, allophanate, biuret, urea, oxadiazinetrione, oxazolidinone, acylurea and/or carbodiimide structures which contain two or more free NCO groups.

Examples of such di- or triisocyanates are tetramethylene-diisocyanate, cyclohexane-1,3- and 1,4-diisocyanate, hexamethylene-diisocyanate (HDI), 1-isocyanato-3,3,5-trimethyl-5-isocyanatomethyl-cyclohexane(isophorone-diisocyanate, IPDI), methylene-bis-(4-isocyanatocyclohexane), tetramethylxylylene-diisocyanate (TMXDI), triisocyanatononane, toluylene-diisocyanate (TDI), diphenylmethane-2,4′- and/or 4,4′-diisocyanate (MDI), triphenylmethane-4,4′-diisocyanate, naphthylene-1,5-diisocyanate, 4-isocyanatomethyl-1,8-octane-diisocyanate (nonane-triisocyanate, triisocyanatononane, TIN) and/or 1,6,11-undecane-triisocyanate and any desired mixtures thereof and optionally also mixtures of other di-, tri- and/or polyisocyanates.

Such polyisocyanates typically have isocyanate contents of from 0.5 to 60 wt. %, preferably 3 to 30 wt. %, particularly preferably 5 to 25 wt. %.

Preferably, the higher molecular weight compounds which have isocyanurate, urethane, allophanate, biuret, iminooxadiazinetrione, oxadiazinetrione and/or uretdione groups and are based on aliphatic and/or cycloaliphatic diisocyanates are employed in the process according to the invention.

Particularly preferably, compounds which have biuret, iminooxadiazinedione, isocyanurate and/or uretdione groups and are based on hexamethylene-diisocyanate, isophorone-diisocyanate and/or 4,4′-diisocyanatodicyclohexylmethane are employed in component aa) in the process according to the Invention.

Very particularly preferably, polyisocyanates which have an isocyanurate structure and are based on hexamethylene-diisocyanate and/or isophorone-diisocyanate are employed.

Monofunctional blocking agents which can be split off by means of heat and are known per se in the technical field are employed as blocking agents for the isocyanate groups of component aa). Examples are phenols, oximes, such as butanone oxime, acetone oxime or cyclohexanone oxime, lactams, such as ε-caprolactam, amines, such as N-tert-butylbenzylamine or diisopropylamine, 3,5-dimethylpyrazole, triazole, esters containing deprotonatable groups, such as malonic acid diethyl ester, acetoacetic acid ethyl ester, or mixture thereof and/or mixtures with other blocking agents. Butanone oxime, acetone oxime, 3,5-dimethylpyrazole, malonic acid diethyl ester, acetoacetic acid ethyl ester and/or mixtures thereof are preferred, and 3,5-dimethylpyrazole is particularly preferred.

The preparation and/or use of component aa can take place in a solvent, and examples are N-methylpyrrolidone, N-ethylpyrrolidone, xylene, solvent naphtha, toluene, butyl acetate, methoxypropyl acetate, acetone or methyl ethyl ketone. It is possible to add solvents after the isocyanate groups have reacted. Protic solvents, such as alcohols, which serve, for example, to stabilize the solution or to improve lacquer properties, can also be used here. Any desired mixtures of solvents are also possible. The amount of solvents is in general such that 20 to 99 wt. % strength, preferably 50 to 90 wt. % strength solutions result. The preparation of solvent-free systems is also possible.

Catalysts can also be added to accelerate the crosslinking. Suitable catalysts are, for example, tertiary amities, compounds of tin, zinc or bismuth, or basic salts, Dibutyltin dilaurate and tin dioctoate are preferred.

Suitable compounds of the isocyanate-reactive component ab), such as, for example, polyhydroxy compounds, are known per se to the person skilled in the art with respect to the preparation and use of such stoving lacquers. These are preferably the binders known per se based on polyhydroxy-polyesters, polyhydroxy-polyurethanes, polyhydroxy-polyethers, polycarbonate diols or on polymers containing hydroxyl groups, such as the polyhydroxy-polyacrylates, polyacrylate-polyurethanes and/or polyurethane-polyacrylates known per se.

b) Copper- or manganese-doped zinc sulfide crystals are preferably used as pigments which luminesce in the electric field. These are encapsulated with inorganic layers, such as, for example, aluminium oxide, since the non-encapsulated pigments are sensitive to moisture during operation. Encapsulated pigments are prior art, known to the person skilled in the art and commercially obtainable, for example from GTP (Global Tungsten & Powders Corp, Hawes Street, Towanda, Pa. 18848, USA).

c) Solvents which can be used are in principle all the solvents known to the person skilled in the art which are suitable for the polyurethanes described, such as, for example, ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or any desired mixtures of two or more of these solvents, in amounts of from preferably 1 to 50 wt. %, preferably 2 to 30 wt. %, particularly preferably 5 to 15 wt. %, in each case based on the total paste composition.

d) 0.1 to 2 wt. % of additives for improving the flow properties and the flow can furthermore be present. Examples of flow agents are Additol XL480 from Cytec Surface Specialties Germany GmbH & Co KG (D-65203 Wiesbaden, www.cytec.com) in Butoxyl in a mixing ratio of from 40:60 to 60:40. 0.01 to 10 wt. %, preferably 0.05 to 5 wt. %, particularly preferably 0.1 to 2 wt. %, in each case based on the total paste composition, of rheology additives which reduce the settling properties of pigments and fillers in the formulation, for example BYK 410, BYK 411, BYK 430, BYK 431 (BYK-Chemie, 46483 Wesel, Germany) or any desired mixtures thereof, can be present as further additives.

Dielectric Layer (4)

As a rule, an insulating or dielectric layer is also present between the back electrode and the pigment layer. This improves the dielectric strength between the two electrode layers serving as capacitor plates during operation.

The dielectric layer comprises
a) a binder system comprising at least
   aa) an isocyanate component
   ab) an isocyanate-reactive component
b) optionally a filler, preferably an inorganic filler, which has the highest possible dielectric constant,
c) optionally solvents
d) optionally additives.

The binder system a) contained in the dielectric layer corresponds to the hinder system contained in the pigment layer and is described there.
b) The formulations for the production of the insulating, dielectric layer can preferably contain barium titanate as a filler. Other materials can furthermore be used, such as e.g. lead zirconate titanate or titanium dioxide. Further filler materials for a formulation for the production of a dielectric layer are known to the person skilled in the art from the literature, for example: BaTiO₃, SrTiO₃, KNbO₃, PbTiO₃, LaTaO₃, LiNbO₃, GeTe, Mg₂TiO₄, Bi₂(TiO₃)₃, NiTiO₃, CaTiO₃, ZnTiO₃, Zn₂TiO₄, BaSnO₃, Bi(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ or mixtures of two or more of these fillers, BaTiO₃ or PbZrO₃ or mixtures thereof, preferably in filler amounts of from 5 to 80 wt. %, preferably from 10 to 75 wt. %, particularly preferably from 40 to 70 wt. %, in each case based on the total weight of the paste, are preferred according to the invention as the filler in the paste for the production of the dielectric layer.
c) Solvents which can be used are in principle all the solvents known to the person skilled in the art which are suitable for the polyurethanes described, such as, for example, ethoxypropyl acetate, ethyl acetate, butyl acetate, methoxypropyl acetate, acetone, methyl ethyl ketone, methyl isobutyl ketone, cyclohexanone, toluene, xylene, solvent naphtha 100 or any desired mixtures of two or more of these solvents, in amounts of from preferably 1 to 50 wt. %, preferably 2 to 30 wt. %, particularly preferably 5 to 15 wt. %, in each case based on the total paste composition.
d) 0.1 to 2 wt. % of additives for improving the flow properties and the flow can furthermore be present. Examples of flow agents are Additol XL480 from Cytec Surface Specialties Germany GmbH & Co KG (D-65203 Wiesbaden, www.cytec.com) in Butoxyl in a mixing ratio of from 40:60 to 60:40. 0.01 to 10 wt. %, preferably 0.05 to 5 wt. %, particularly preferably 0.1 to 2 wt. %, in each case based on the total paste composition, of rheology additives which reduce the settling properties of pigments and fillers in the formulation, for example BYK 410, BYK 411, BYK 430, BYK 431 (BYK-Chemie, 46483 Wesel, Germany) or any desired mixtures thereof, can be present as further additives.

The formulations and pastes according to the invention are suitable for the production of both two-dimensional EL elements and EL elements three-dimensionally shaped by means of isostatic high pressure forming. The three-dimensional shaping of the film element is configured in this context such that one or more depressions or projections are shaped into the fiat film element. The formulations are furthermore suitable for the production of EL elements which can be subjected to insert moulding. For this, the layers which are produced by application and drying and/or crosslinking of the formulations according to the invention must withstand the temperatures and pressures in the shaping process and insert moulding process.

### DESCRIPTION OF THE DRAWING

1—Film substrate
2—Front electrode
3—Pigment layer
4—Dielectric layer
5—Back electrode

FIG. 1 shows an EL element of conventional construction. The light is emitted through the substrate.

FIG. 2 shows an EL element of inverse construction. The light is emitted to the side facing away from the substrate.

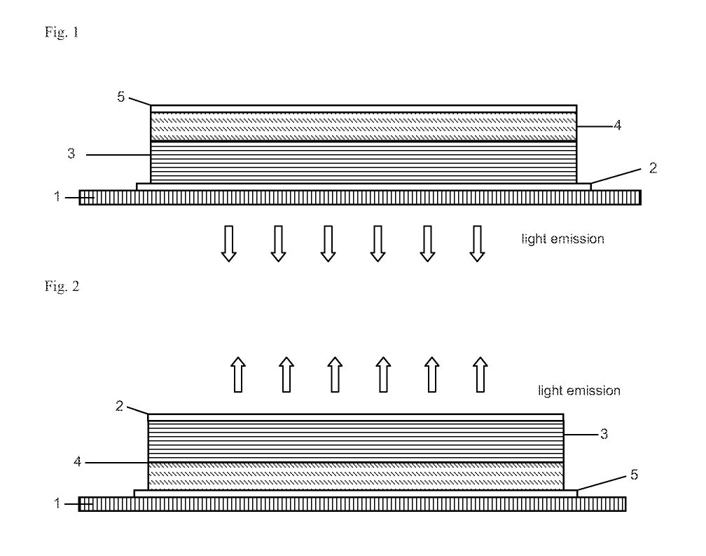

### EXAMPLES

The examples given here are intended to illustrate the invention and render it plausible, but they in no way limit it to the information used in the examples,

Desmodur® BL 3475 BA/SN is an aliphatic crosslinking stoving urethane resin with blocked isocyanate groups, based on HDI/IPDI, delivery form approx. 75% strength in Solventnaphtha® 100/butyl acetate (1:1), NCO content, blocked approx. 8.2%, Bayer MaterialScience AG, Leverkusen, DE

Desmophene® 670 BA is a slightly branched polyester containing hydroxyl groups, de⁻lively form approx. 80% strength in butyl acetate, hydroxyl content 3.5±0.3% (DIN 53 240/2), Bayer MaterialScience AG, Leverkusen, DE

Desmophen® 1800 is a solvent-free polyester containing OH groups with little crosslinking, hydroxyl content 1.82±0.09% (ISO 6796), Bayer MaterialScience AG, Leverkusen, DE

### Example 1

For production of a pigment layer according to the invention, formulations contain the following recipes:

TABLE 1

| | Recipe P1 | Recipe P2 |
|---|---|---|
| | Weight in | Weight in |
| Substance | wt. % | wt. % |
| Desmodur BL3475 BA/SN (Bayer | 22.6 | 20.12 |
| MaterialScience AG) | | |
| Desmophen 670 (Bayer MaterialScience AG) | 13.1 | 15.58 |
| Ethoxypropyl acetate | 3.3 | 3.30 |
| Additol 480 XL (Cytec) in Butoxyl (50:50) | 2.5 | 2.50 |
| Pigment (GTP, Towanda, PA, USA) | 58.5 | 58.50 |

For production of a dielectric layer according to the invention, formulations contain the following recipes:

TABLE 2

| | Recipe D1 | Recipe D2 |
|---|---|---|
| | Weight in | Weight in |
| Substance | wt. % | wt. % |
| Desmodur BL3475 BA/SN (Bayer | 25.1 | 22.37 |
| MaterialScience AG) | | |
| Desmophen 670 (Bayer MaterialScience AG) | 14.6 | 17.33 |
| Ethoxypropyl acetate | 3.6 | 3.60 |
| Additol 480 XL in Butoxyl (50:50) | 2.7 | 2.70 |
| Barium titanate (e.g. Sigma Aldrich, | 54.0 | 54.00 |
| www.sigmaaldrich.com) | | |

### Example 2

For production of a pigment layer according to the invention, formulations contain the following recipes:

TABLE 3

| | Recipe P3 | Recipe P4 |
|---|---|---|
| | Weight in | Weight in |
| Substance | wt. % | wt. % |
| Desmodur BL3475 BA/SN (Bayer | 12.6 | 11.62 |
| MaterialScience AG) | | |
| Desmophen 1800 (Bayer Material Science) | 23.1 | 21.59 |
| Pigment (GTP, Towanda, PA, USA) | 58.5 | 59.04 |
| Ethoxypropyl acetate | 3.3 | 0 |
| Dipropylene glycol dimethyl ether | 0 | 7.38 |
| Additol 480 XL in Butoxyl (50:50) | 2.5 | 0 |
| Borchi Gol LA200 (OMG Borchers GmbH, | 0 | 0.37 |
| D-40764 Langenfeld, Germany) | | |

For production of a dielectric layer according to the invention, formulations contain the following recipes:

TABLE 4

| | Recipe D3 |
|---|---|
| | Weight in |
| Substance | wt. % |
| Desmodur BL3475 BA/SN (Bayer MaterialScience AG) | 14.0 |
| Desmophen 1800 (Bayer MaterialScience AG) | 25.7 |
| Ethoxypropyl acetate | 3.6 |
| Additol 480 XL in Butoxyl (50:50) | 2.7 |
| Barium titanate (Sigma Aldrich, www.sigmaaldrich.com) | 54.0 |

Example for the production of an EL element by screen printing using formulations which contain blocked isocyanates:

All the layers described in the example were printed on with an ATMACE screen printing machine (ESC Europa-Siebdruckmaschinen-Centrum Verwaltungsges. mbH, 32108 Bad Salzuflen, Germany). The first electrically conductive layer as described in WO 2008/071412 on page 21 in the left-hand column of the table, compare Table 5, was printed on to a polycarbonate film (Bayfol CR 1-4 250 μm, Bayer MaterialScience AG):

TABLE 5
Composition of a formulation for the production of an
electrically conductive layer, as described in WO 2008/071412,
page 21, left-hand column of the table.

| | Weight in |
|---|---|
| Substance | wt. % |
| Clevios P HS (formerly Baytron P HS; H. C. Starck) | 33.0 |
| Silquest A187 (OSI Specialties) | 0.4 |
| N-Methylpyrrolidone | 23.7 |
| Diethylene glycol | 26.3 |
| Proglyde/DMM | 12.6 |
| Bayderm Finish 85 UD (Lanxess) | 4.0 |

After drying of the electrically conductive layer (30 minutes at 110° C.), a pigment layer (according to Table 1, Recipe P1) was printed on wet-in-wet. The pigment layer was dried in a belt drier at 110° C. for five minutes and then in a drying cabinet at 110° C. for a further 10 minutes, The dielectric layer (according to Table 2, Recipe D1) was then printed on wet-in-wet and likewise dried at 110° C. in a belt drier for five minutes and in a drying cabinet for 10 minutes. These temperatures were chosen since the substrate used becomes corrugated at higher temperatures in a drying cabinet and the blocked isocyanate used is no longer deblocked at lower temperatures. A second electrically conductive layer was then printed on, for which the same formulation as for the first electrically conductive layer was used. After drying of this electrically conductive layer (30 minutes at 110° C. in a drying cabinet), the EL element was completed by printing on silver busbars (Acheson Electrodag PM-470) to amplify the electrical conductivity of the electrodes.

The pigment paste already used can be removed from the screen after the printing. In the case of screens in frame sizes of 1.150 mm by 1.350 mm, a flooding amount of about one to one and a half kilograms of formulation is furthermore necessary. Bath the flooding amount and residues Which have been prepared in excess can be stored for weeks in closed drums of plastic and used again at any time. In the case of the pastes prepared in the comparison example (Recipe P2), re-use is no longer possible since the paste undergoes such a marked increase in viscosity within a few hours due to crosslinking of the binder that it can no longer be used for printing without defects.

In order to document the advantage offered by a system with a blocked isocyanate, the viscosity was determined after preparation and after several hours. The systems used were the binder Desmodur 3475 BA/SN mentioned in the example with Desmophen 670, and the system described, in WO2008068016 (EL element containing a semitransparent metal foil and production method and use) (Desmodur N75 MPA and Desmophen 670) was used as the comparison system. Flow additives and fillers were not used for measurement of the viscosities, since only the reaction of the isocyanate with the polyol is to be monitored here. The aim of the viscosity measurements is monitoring of the reaction. In this context, it is found that the viscosity of the mixture with the non-blocked isocyanate (Desmodur N75 MPA) increases due to the crosslinking of the binder, while the mixture with the blocked isocyanate does not react and the viscosity changes only marginally. The change in viscosity is thus decidedly not its absolute value. This depends inter alia on the amount of solvent, which differs in the two batches.

The following batches were prepared for the viscosity determinations:

Comparison example (non-blocked isocyanate):

| Substance | Content/wt. % |
|---|---|
| Desmophen 670 | 35.6 |
| Ethoxypropyl acetate | 37.3 |
| BYK 410 | 0.5 |
| Desmodur N75 MPA | 26.6 |

Example according to the invention (formulation with blocked isocyanate):

| Substance | Content/wt. % |
|---|---|
| Desmophen 670 | 33.0 |
| Ethoxypropyl acetate | 8.3 |
| BYK 410 | 0.4 |
| Desmodur 3475 BA/SN | 58.3 |

The viscosity of these formulations was measured after preparation, after four to five hours, and after approx. 24 hours.

The non-blocked system (Desmodur 175 MPA)—comparison example—shows only a slight increase in the viscosity (0.388 mPa·s to 0.451 mPa·s at a shear rate of 10 s⁻¹) within the first 5 hours, but a doubling of the viscosity after a total of 17 h (0.953 mPa·s at 10 s⁻¹).

The blocked system (Desmodur 3475)—example according to the invention—has a viscosity of 1.98 mPa·s at 10 s⁻¹ after preparation of the formulation, a viscosity of 1.93 mPa·s at 10 s⁻¹ four and a half hours after preparation of the formulation and a viscosity of 2.00 mPa·s at 10 s⁻¹ after 27 hours. The viscosity thus does not increase.

Three days after preparation of the formulations, the non-blocked system is solid (no longer measurable), whereas the blocked system is unchanged and can continue to be used.

The viscosity measurements were carried out on a Physica MCR 301 from Anton Paar GmbH (8054 Graz, Austria). The temperature was set at 25.0° C. for all the measurements. A cone/plate arrangement was used, the cone having a diameter of 49.966 mm and the cone angle being 1.994°.

1. An EL element comprising:
a substrate, a front and a back electrode and a pigment layer, wherein the pigment layer comprises:
a) a binder system comprising:
a component with thermally reversibly blocked isocyanate groups aa),
and at least one isocyanate-reactive components ab), and
b) pigments or crystals which are luminescent in an electric field.

2. The EL element according to claim 1, wherein said binder system comprises as component aa):
aliphatic, cycloaliphatic, araliphatic and/or aromatic di- or triisocyanates and higher molecular weight secondary products thereof with iminooxadiazinedione, isocyanurate, uretdione, urethane, allophanate, biuret, urea, oxadiazinetrione, oxazolidinone, acylurea and/or carbodiimide structures which contain at least two free NCO groups, and as component ab) phenols, oximes, optionally comprising butanone oxime, acetone oxime or cyclohexanone oxime, lactams, optionally comprising ε-caprolactam, amines, optionally comprising N-tert-butylbenzylamine or diisopropylamine, 3,5-dimethylpyrazole, triazole, esters containing deprotonatable groups, optionally comprising malonic acid diethyl ester, acetoacetic acid ethyl ester, and/or mixtures thereof and/or mixtures with other blocking agents.

3. The EL element according to claim 2, wherein component aa) is at least one selected from the group consisting of tetramethylene-diisocyanate, cyclohexane-1,3- and 1,4-diisocyanate, hexamethylene-diisocyanate (HDI), 1-isocyanato-3,3,5-trimethyl-5-isocyanatomethylcyclohexane (isophorone-diisocyanate, IPDI), methylene-bis-(4-isocyanatocyclohexane), tetramethylxylylene-diisocyanate (TMXDI), triisocyanatononane, toluylene-diisocyanate (TDI), diphenylmethane-2,4′- and/or 4,4′-diisocyanate (MDI), triphenylmethane-4,4′-diisocyanate, naphthylene-1,5-diisocyanate, 4-isocyanatomethyl-1,8-octane-diisocyanate (nonane-triisocyanate, triisocyanatononane, TIN) and 1,6,11-undecane-triisocyanate.

4. The EL element according to claim 2, wherein component ab) is at least one selected from the group consisting of butanone oxime, acetone oxime, 3,5-dimethylpyrazole, malonic acid diethyl ester and acetoacetic acid ethyl ester.

5. The EL element according to claim 1, wherein said isocyanate groups aa) have isocyanate contents of from 0.5 to 60 wt. % based on component aa.

6. The EL element according to claim 1, comprising at least one further layer selected from the group consisting of a dielectric layer and a covering layer.
